(19) United States
(12) Patent Application Publication
(10) Pub. No.: US 2005/0170077 A1
(43) Pub. Date: Aug. 4, 2005

(54) Adhesion method

(75) Inventors: Joseph R. Montano, Boston, MA (US); James G. Shelnut, Northboro, MA (US)

Correspondence Address: EDWARDS & ANGELL, LLP, P.O. BOX 55874, BOSTON, MA, 02205, US

(73) Assignee: Shipley Company, L.L.C., Marlborough, MA (US)

(21) Appl. No.: 11/090,685

(22) Filed: Mar. 25, 2005

Related U.S. Application Data
(62) Division of application No. 10/620,893, filed on Jul. 16, 2003.
Application No. 10/620,893 is a continuation-in-part of application No. 09/995,890, filed on Nov. 28, 2001, now Pat. No. 6,616,976.
(60) Provisional application No. 60/253,472, filed on Nov. 28, 2000.

(51) Int. Cl. B05D 3/00

(52) U.S. Cl. 427/96.1

(57) ABSTRACT

A primer composed of a polymer solution is applied to a roughened metal surface, and a polymer material such as a pre-preg is applied to the treated metal surface to form a bond between the metal and the polymer material.

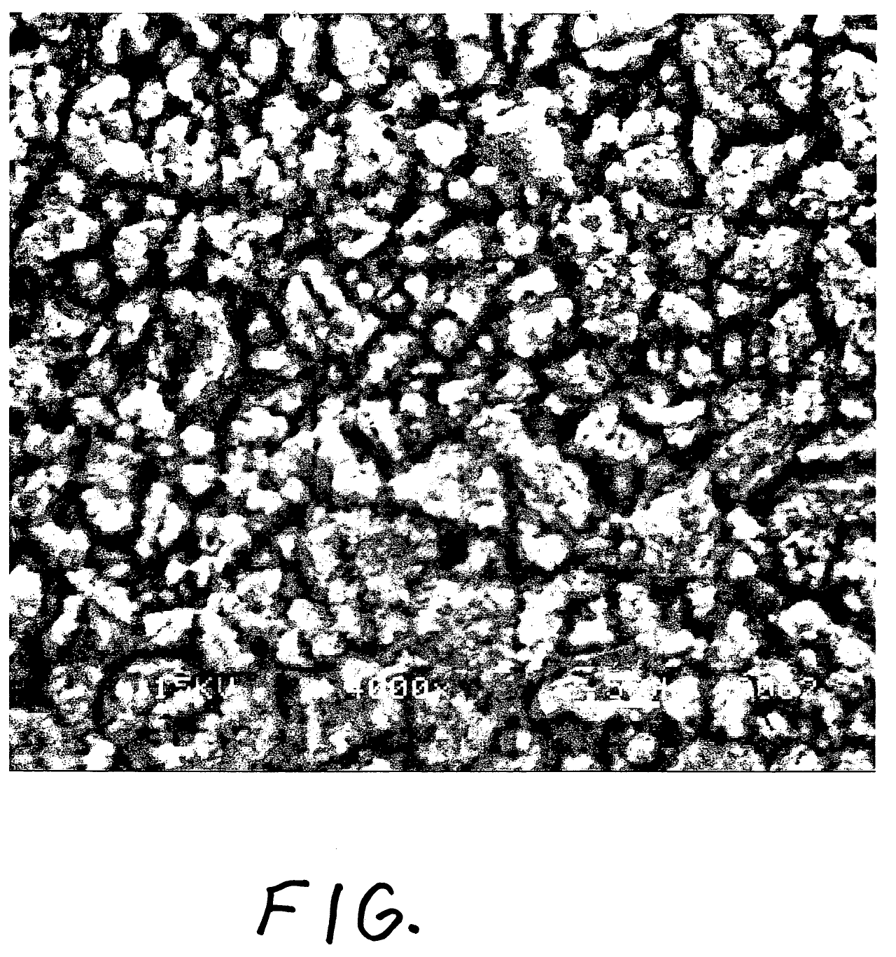

### BACKGROUND OF THE INVENTION

The Present invention is directed to a method of improving adhesion between a roughened metal surface and a polymer material by treating the roughened metal surface with a primer composition. More specifically, the present invention is directed to a method of improving adhesion between a roughened metal and a polymer material by treating the roughened metal surface with a primer composition that includes an organic polymer, an organic oligomer, an organic monomer, or mixtures thereof.

In the fabrication of multi-layer printed circuits, patterned circuitry inner-layers are first prepared by a process in which a copper foil-clad dielectric substrate material is patterned with resist in the positive image of the desired circuitry pattern followed by etching away of the exposed copper. Upon removal of the resist, there remains the desired copper circuitry pattern. One or more circuitry inner-layers of any particular type or types of circuitry pattern, as well as circuitry inner-layers which might constitute ground planes and power planes, are assembled into a multi-layer circuitry by interposing one or more partially-cured dielectric substrate material layers (so called “pre-preg”layers) between the circuitry inner-layers to form a composite of alternating circuitry inner-layers and dielectric substrate material. The composite is then subjected to heat and pressure to cure the partially cured substrate material and achieve bonding of circuitry inner-layers thereto. The cured composite will than have a number of through-holes drilled therethrough, which are then metallized to provide a means for conductivity interconnecting all circuitry layers. In the course of the through-hole metallizing process, desired circuitry patterns also typically form in the outer facing layers of the multilayer composite.

An alternate approach to the formation of a multi-layer printed circuit board is through additive or surface laminar circuitry techniques. These techniques begin with a non-conductive substrate, upon which the circuit elements are additively plated. Further layers are achieved by repeatedly applying an imageable coating upon the circuitry and plating further circuit elements upon the imageable coating.

The strength of the adhesive bond formed between the copper metal of the circuitry inner-layers and the cured pre-preg layers, or other non-conductive coatings, in contact therewith leaves something to be desired, with the result that the cured multi-layer composite or the coating is susceptible to delamination in subsequent processing and/or use. In response to this problem, the art developed the technique of forming on the copper surfaces of the circuitry inner-layers (before assembling them with pre-preg layers into a multi-layer composite) a layer of copper oxide, such as by chemical oxidation of the copper surfaces. The earliest efforts in this regard (so-called “black oxide” adhesion promoters) produced somewhat minimal improvement in the bonding of the circuitry inner-layers to the dielectric substrate layers in the final multi-layer circuit, as compared to that obtained without copper oxide provision.

As noted earlier, the assembled and cured multi-layer circuit composite is provided with through-holes which then require metallization in order to serve as a means for conductive interconnection of the circuitry layers of the circuit. The metallizing of the through-holes involves steps of resin desmearing of the hole surfaces, catalytic activation, electroless copper depositing, electrolytic copper depositing, and the like. Many of these process steps involve the use of media, such as acids, which are capable of dissolving the copper oxide adhesion promoter coating on the circuitry inner-layer portions exposed at or near the through-hole. This localized dissolution of the copper oxide, which is evidenced by formation around the through-hole of a pink ring halo (owing to the pink color of the underlying copper metal thereby exposed), can in turn lead to localized delamination in the multi-layer circuit. The art is well aware of this “pink ring” phenomenon, and has expended extensive effort to such localized delamination. One suggested approach has been to provide the adhesion promoting copper oxide as a thick coating so as to retard its dissolution in subsequent processing simply by virtue of sheer volume of copper oxide present. This turns out to be essentially counter-productive, however, because the thicker oxide is inherently less effective as an adhesion promoter per se. Other suggestions relating to optimization of the pressing/curing conditions for assembling the multi-layer composite have met with only limited success.

U.S. Pat. No. 4,642,161, U.S. Pat. No. 4,902,551 and U.S. Pat. No. 4,981,560 relate to processes in which the copper surfaces of the circuitry inner-layers prior to incorporation of the circuitry inner-layers into a multi-layer circuit assembly are first treated to provide a surface coating of adhesion-promoting copper oxide. The copper oxide is then reduced to metallic copper using particular reducing agents and conditions. As a consequence the multi-layer assembly employing such circuitry inner-layers will not evidence pink ring formation since there is no copper oxide present for localized dissolution, and localized exposure of underlying copper, in subsequent through-hole processing. As with other techniques, however, process of this type are suspect in terms of the adhesion attainable between the dielectric substrate layers and the metallic copper circuitry inner-layers. This is particularly so in these reduction processes since the circuitry bonding surface not only is metallic copper, but also presents the metallic copper in distinct phases (i.e. (1) copper-from-reduction-of-copper oxide over (2) copper of the copper foil) which are prone to separation/delamination along the phase boundry.

U.S. Pat. No. 4,997,722 and U.S. Pat. No. 4,997,516 similarity involve formation of a copper oxide coating on the copper surfaces of circuitry inner-layers, followed by treatment with a specialized reducing solution to reduce the copper oxide to metallic copper. Certain portions of the copper oxide apparently may not be reduced all the way to metallic copper (being reduced instead to hydrous cuprous oxide or cuprous hydroxide), and those species are thereafter dissolved away in a non-oxidizing acid which does not attack or dissolve the portions already reduced to metallic copper. The multi-layer assembly employing such circuitry inner-layers does not evidence pink ring formation since there is no copper oxide present for localized dissolution, and localized exposure of underlying copper, in subsequent through-hole processing. However, problems may arise in terms of adhesion between the dielectric layers and metallic copper circuitry inner-layers, firstly because the bonding surface is metallic copper, and secondly because the metallic copper predominantly is present in distinct phases (i.e., (1) copper-from-reduction-of-copper oxide over (2) copper of the copper foil), a situation prone to separation/delamination along the phase boundary.

PCT Application WO 96/19097 discloses a process for the adhesion of polymeric materials to a metal surface. The process involves contacting the metal surface with an adhesion promoting composition containing hydrogen peroxide, an inorganic acid, a corrosion-inhibitor and a quaternary ammonium surfactant to form a micro-roughened, conversion coated metal surface. A pre-preg polymer material may be placed to form an alleged high integrity bond with the conversion coated metal surface.

U.S. Pat. No. 5,869,130 describes a process for improving the adhesion of polymeric materials to a metal surface, especially copper or copper alloy surfaces, in the production of multi-layer printed circuits. The process described in this patent application discloses a method where a metal surface is contacted with an adhesion-promoting composition composed of (a) an oxidizer; (b) and acid; (c) a corrosion inhibitor; (d) a source of halide ions; and (e) optionally, a water-soluble polymer. The process allegedly provides excellent adhesion between the metallic and polymeric surfaces (i.e., the circuitry and the intermediate insulating layer), while eliminating or minimizing pink ring and operating economically.

U.S. Pat. No. 6,020,029 discloses an acidic peroxide, adhesion promotion composition containing an oxidizer, an acid, a corrosion inhibitor, optionally a source of halide ions and optionally a water-soluble polymer. The composition is applied to a metal surface. After the acidic peroxide solution is applied to the metal, the metal is post-treated with a strong alkaline solution followed by rinsing with water. After the metal is post-treated, a polymeric material is bonded to the metal surface. The '029 patent alleges that the combination of the halide and water-soluble polymer in the acidic peroxide composition provide the best bonding results between the metal surface and the polymeric material.

Although there are methods that may improve the bonding integrity between a metal surface and a polymeric material, there is still a desire and a need in the circuit board industry to increase adhesion between a metal surface and a polymeric material. Many of the above disclosed methods cause the formation of a textured surface on the metal. However, none attempt to exploit the textured metal surface to further enhance bonding between the metal and the polymeric material. Accordingly, there is a need for a process that exploits the textured surface of the metal to improve the adhesive properties between the metal and the polymeric material.

### SUMMARY OF THE INVENTION

The present invention is directed to a process that includes roughening a metal surface followed by treating the roughened metal surface with a liquid primer that includes an organic polymer, an organic oligomer, an organic monomer or mixtures thereof and then placing a polymer material on the liquid primed and roughened metal surface such that a bond is formed between the primed and roughened metal and the polymer material. The metal may be roughened by any suitable process known in the art such as a mechanical or chemical process. Primers may include both aqueous and organic based solutions or dispersions of organic polymers, organic oligomers, organic monomers or mixtures thereof that prime a roughened metal surface to receive a polymer material and form a bond.

The liquid primer composition of the present invention that includes an organic polymer, an organic oligomer, an organic monomer or mixtures thereof may readily be applied to a roughened metal surface as a thin layer. A polymer material, as a layer or pre-preg, may be applied to the roughened metal layer with a layer of liquid primer followed by mechanical pressure, heat, or combinations of mechanical pressure and heat to form a high integrity bond between the polymer material and the metal.

The method of the present invention provides for improved adhesion between a roughened metal surface and a polymer material in contrast to many conventional methods practiced in the art. Adhesion between the roughened metal surface and the polymeric material is such that multi-layer circuit boards prepared using the method of the present invention may be employed to make electronic devices without concern that the polymer material may delaminate or peel from the metal surface.

### BRIEF DESCRIPTION OF THE DRAWING

FIGURE is a 4000×SEM of a roughened copper surface treated with an oxide alternative bath prior to inner-layer bonding with a polymer material.

### DETAILED DESCRIPTION OF THE INVENTION

The present invention is directed to a process that includes roughening a metal surface followed by treating the roughened metal surface with a liquid primer that includes an organic polymer, an organic oligomer, an organic monomer, or mixtures thereof and then placing a polymer material on the liquid primed and roughened metal surface to form a bond between the liquid primed and roughened metal and the polymer material. Primer compositions may include both aqueous and organic based solutions or dispersions of organic polymers, organic oligomers, organic monomers or mixtures thereof that prime a roughened metal surface to receive a polymer material and form a bond. The polymer material may be applied to the roughened metal surface by lamination to form a polymer layer on the roughened metal surface.

Metals may be roughened by any suitable method known in the art. Such methods include but are not limited to mechanical and chemical roughening. Roughening involves forming a porous or textured surface or layer on the metal such that a polymer material may form a lock and key bond with the roughened surface of the metal. Mechanical roughening may be performed with materials such as diamond, garnet, pumice or any suitable material that is harder than the metal surface to be roughened. Such materials may be applied to a metal surface by any suitable method or apparatus known in the art. For example, a compressed air blasting apparatus, such as used in sand blasting or comparable apparatus may be employed to apply diamond, garnet, pumice or other abrasive particles to roughen a metal surface. Hand rubbing, brushing and mechanical wheels also may be employed to roughen a metal.

Particle sizes of abrasives may vary. Typically particles range in diameter from 100 nanometers to 1000 nanometers. Application of the particles continues until the metal surface has a matte appearance. Application time may range from 30 seconds to 10 minutes depending on the type of material used and the metal to be roughened. Diamond may be applied for a period of from 30 seconds to 2 minutes to provide a suitable mechanically roughened surface. Garnet and pumice, being softer materials than diamond, typically are applied from 2 minutes to 10 minutes.

Diamond, garnet, pumice or other materials may be applied by hand rubbing the materials on a metal surface. When roughening is performed by hand, the roughening period may range from 60 seconds to 10 minutes. The amount of time varies depending on the material used to roughen the metal. Roughening to produce a matte surface with diamond typically ranges from 60 seconds to 2 minutes. Garnet and pumice may take from 3 minutes to 10 minutes to produce a noticeable matte surface. The matte surface is visible to the naked eye.

In an alternative embodiment of the present invention, a metal may be roughened chemically using an oxide alternative bath or solution. Such oxide alternative baths both roughen and conversion-coat a metal surface. Such oxide alternative baths or solutions may include an oxidizer, an acid, a corrosion inhibitor of mixtures thereof. Additional components may be included in the solutions as discussed below. Oxide alternative baths may have a pH of from 2.0 to 13.0.

The FIGURE shows a SEM (scanning electron micrograph) at 4000 power of a copper metal surface roughened and conversion-coated with an aqueous oxide alternative solution composed of hydrogen peroxide, sulfuric acid, benzotriazole, and tetrabutylammonium chloride. A matte appearance may be visible to the naked eye when a metal is roughened with an oxide alternative solution.

The oxidizer used in the oxide alternative solution may comprise any oxidizer that is capable of oxidizing the metal surface. Hydrogen peroxide and persulfates are particularly preferred oxidizers for use in the process of the invention with hydrogen peroxide being the most preferred oxidizer. The concentration of the oxidizer in the oxide alternate solution may range from at least 0.01% by weight based on the total weight of the composition to as high as 60.0% by weight. Preferably, the hydrogen peroxide is present from 0.1 to 20% by weight, more preferably from 0.5% to 10%, and most preferably from 1% to 5%. Hydrogen peroxide is commercially available as, e.g., 35% by weight aqueous solution.

The oxide alternate solution optionally may contain a stabilizing agent for hydrogen peroxide. Any suitable stabilizing agent for hydrogen peroxide may be used. Examples include, but are not limited to, dipicolinic acid, diglycolic acid and thiodiglycolic acid, ethylene diamine tetraacetic acid and its derivatives, magnesium salts of an aminopolycarboxylic acid, sodium silicate, phosphates and sulphonates. Stabilizers are added in the amounts of from 0.001% and preferably at least 0.005% by weight of the solution. More preferably, the concentration of the stabilizing agent varies between 0.5 to 5.0% by weight of the solution.

The acid utilized in the oxide alternate solution may be any acid that is stable in the matrix of the solution. Preferred acids are inorganic acids and may be employed as a single acid or a mixture of acids. A variety of inorganic acids may be used including, but not limited to, sulfuric acid, nitric acid, hydrochloric acid, phosphoric acid and mixtures thereof. Sulfuric acid, phosphoric acid or mixtures thereof is especially preferred. When a mixture of inorganic acids is used, the acids may be combined in any suitable ratio. A ratio of from 99:1 to 1:99, and preferably from 75:25 to 25:75 may be employed. When a mixture of sulfuric acid and phosphoric acid are used, preferably sulfuric acid is used in major amounts and phosphoric in minor amounts. The concentration of the acid in the solution may range from 5 to 360 grams per liter (g/L), preferably from 70 to 110 grams per liter.

The corrosion inhibitor used in the oxide alternate solution is a compound that effectively reacts with the metal surface to form a protective complex layer. Preferred corrosion inhibitors are pyrroles, azoles, oxazoles, thiazoles, pyrazoles, triazoles, benzotriazoles, tetrazoles, tolyltriazol, hydroxy-substituted azole compounds, imidazoles, benzimidazoles such as 5-methylbenzimidazole, 2-bromobenzyl benzimidazole, 2-chlorobenzyl benzimidazole, 2-bromophenyl benzimidazole, 2-chlorophenyl benzimidazole, 2-bromophenyl benzimidazole, 2-chloroetbylphenyl benzimidazole and 2-undecyl-4-methylimidazole, or mixtures thereof. Hydroxy-substituted azole compounds may have more than one hydroxy substituent and may be further substituted, such as with a (C₁-C₆)alkyl, (C₁-C₆)alkoxy, halogen and the like. Suitable hydroxy-substituted azole compounds include, but are not limited to, hydroxy-substituted triazoles and hydroxy-substituted tetrazoles. 1-Hydroxybenzotriazole is a preferred hydroxy-substituted triazole. Examples of suitable benzotriazoles include, but are not limited to, benzotriazole, carboxybenzoxtriazole and mixtures thereof. The corrosion inhibitors are available from a variety of commercial sources and may be employed without further purification. The concentration of the corrosion inhibitor in the solution may range from 0.1 to 20% by weight based on the total weight of the composition, preferably from 0.2 to 1% by weight, and most preferably from 0.3 to 0.6% by weight.

Optionally, a source of halide ions may be employed in the oxide alternate solution. Any suitable source of halides may be employed as long as the source provides halide ions in the matrix of the solution. Examples of suitable sources of halide ions are alkali metal salts such as sodium chloride or potassium chloride, oxohalides such as sodium chlorate or potassium chlorate, or halide bearing mineral acids such as hydrochloric acid. The most preferred sources are halide sources that are free of surfactant groups, such as tetraalkyl ammonium halides, such as tetraalkyl ammonium chloride, tetrabutyl ammonium chloride and mixtures thereof. The concentration of the source of halide ions in the solution may range from 1 ppm (parts per million) to 50 ppm. When chloride is employed, the chloride ion is present in amounts of from 1 ppm to 8 ppm, preferably from 4 ppm to 7 ppm.

Optionally, the oxide alternate solution also comprises a water soluble polymer. The water soluble polymer is a polymer of ethylene oxide, an ethylene oxide-propylene oxide copolymer, polyethylene glycols, polypropylene glycols or polyvinyl alcohols. Among the most preferred are the polymers of ethylene oxide, or polyethylene glycols sold by the Union Carbide company under the tradename Carbowax®. Particularly useful are the ethylene oxide polymers or ethylene oxide-propylene oxide copolymers sold by the BASF company under the Pluronic® tradename. The concentration of the water soluble polymer in the adhesion-promoting composition can range from 1 to 15 grams per liter, but is preferably from 3 to 6 grams per liter.

An additional component that may be added to the oxide alternate solution is an amine or a quaternary ammonium compound. The term amine as used herein is defined as a lower aliphatic, cycloaliphatic or aromatic amine, i.e. a primary, secondary or tertiary amine having C₁ to C₈ substitution. The term quaternary ammonium compound as used herein is also defined as a lower aliphatic, cycloaliphatic or aromatic compound. Each term excludes from its scope materials having fatty substitution or other surfactant groups. Each substituent on the amine may be aliphatic, cycloaliphatic or aromatic and each of such substituents may be further substituted with groups such as carboxyl, nitro, sulfonyl, hydroxyl, and the like. Exemplary amines include methyl amine, dimethylamine, trimethylamine, ethylamine, triethylamine, tripropylamine, isopropylamine, triallylamine, n-butylamine, t-butylamine, n-amylamine, cyclohexyl amine, dicyclohexylamine, and the like. Exemplary quaternary ammonium compounds include tetramethylammonium hydroxide, tetraethylammonium hydroxide, and dimethyl-diethylammonium hydroxide, tetramethylammonium chloride, tetraethylammoium chloride and dimethyl-dimethylammonium chloride. The amines are used in a concentration of from 0.01% by weight to 2.5% by weight and more preferably, in a concentration of from 0.1 to 1.0% by weight.

Prior to applying an oxide alternative solution to a metal, the metal surface preferably is cleaned by mechanical or chemical cleaning and then contacted with the oxide alternative solution. The metal surface may be treated with the oxide alternative solution in a variety of ways, including immersion, spray or flood. The temperature of the oxide alternative solution during treatment preferably does not exceed 75° C. and more preferably, the oxide alternative solution is from 20° C. to 50° C. Contact time is at least 1 second and preferably from 5 seconds to 2 minutes. The maximum contact time of the oxide alternative solution to the metal surface is minutes.

After the metal is roughened a primer composition including one or more organic polymers, one or more organic oligomers, one or more organic monomers, or mixtures thereof in solution or dispersion form is applied to the roughened metal surface. Organic polymers, organic oligomers or organic monomers within the scope of the present invention means that the polymer, oligomer or monomer has a carbon, nitrogen, oxygen or combinations thereof in its structure with the exclusion of epoxy compounds and silicon containing compounds or polymers such as organo-silicon compounds and silsesquioxanes. Oligomers and monomers within the scope of the present invention may have at least one α,β-ethylenically or acetylenically unsaturated group or moiety.

The roughened metal may be spray-coated, dip-coated, or roller coated with the primer composition, or the primer composition may be applied to the metal with a squeegee, or any other suitable method known in the art. The methods and apparatus for applying the primer to the roughened metal surface may be horizontal or vertical.

Primers within the scope of the present invention are aqueous based or organic solvent based solutions or dispersions. The primer is composed of from 0.5% by weight to 95% by weight of an organic polymer, an organic oligomer or an organic monomer, preferably from 0.5% by weight to 50% by weight of the primer composition. While not being bound to theory, Applicants believe that the primer permits an organic polymer, oligomer or monomer in solution or as a dispersion to penetrate the roughened metal surface thereby increasing contact between the metal and a polymer material to be bonded to the metal surface. The primer composition enables improved adhesion between a roughened metal surface and a polymer material. Not only does the primer improve adhesion between a polymer material and a roughened surface treated with an oxide alternative solution, but more surprisingly adhesion is improved between a polymer material and a metal roughened by mechanical means as well. Such mechanically roughened metal surfaces are not as textured as metal surfaces roughened with an oxide alternative solution but yet the mechanically roughened metal surface is suitable for making multi-layer printed wiring boards. The primer of the present invention improves the integrity of the bond between a polymer material and the roughened metal surface such that metal surfaces roughened mechanically as well as using an oxide alternative solution are suitable for making laminates with a high peel strength such peel strengths range from 4-10 pounds per linear inch, preferably from 6-8 pounds per linear inch. There are 453.6 grams/pound and 2.54 centimeters/inch.

Polymers that are suitable for use in the primer of the present invention include polymers that form aqueous or organic solvent based solutions or dispersion. The primers may be true solutions or dispersions depending upon the solubility of the polymer employed. Surfactants may be employed to solubilize the polymers or disperse them in the solvent. Preferably the solution or dispersion applied to the roughened metal surface is uniform and remains uniform during application of the polymer material to the roughened metal surface. Examples of suitable polymers that may be employed in primer solutions include, but are not limited to, polyimides, novolak resins, polyacrylates, polycyanoacrylates, rubbers, polyurethanes, polycarbonates, butadienes or mixtures thereof.

In addition to organic polymers, organic oligomers, organic monomers, or mixtures thereof, primers of the present invention also may include epoxies, silsesquioxanes, organo-silicon compounds such as organosilane compounds and organosiloxanes, or combinations thereof.

Examples of suitable epoxies that may be employed to practice the present invention include, but are not limited to, epoxies having the following formula: 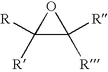
where R, R′, R″, and R′″ include, but are not limited to, independently, hydrogen; alkyl; aryl; aralkyl; or a cyclic radical. R′, R″, and R′″ are preferably hydrogen when R is alkyl, aryl, aralkyl, or a cyclic radical such as a cyclo-aliphatic radical. The alkyl, aryl, aralkyl and cyclo-aliphatic groups may be unsubstituted, or substituted with an alkyl group, an aryl group, an arylkyl group, or a halogen such as bromine or chlorine. Each of the alkyl groups preferably range from one carbon to 20 carbons, most preferably from one carbon to 12 carbons.

Illustrative of the epoxies employed within the scope of the present invention include aliphatic epoxies, cycloaliphatic epoxies, bisphenol A-epoxies, 3,4-epoxy cyclohexyl methyl 3,4-epoxy cyclohexyl carboxylate, and the like. Also included are epoxy formulations based on glycidyl ethers of para amino phenols as described in U.S. Pat. No. 5,514,729. Other suitable epoxies that may be employed to practice the present invention include, but are not limited to, those derived from bisphenol S, bisphenol F, novolak resins, and the epoxies obtained from the reaction of bisphenol A and epihalohydrins. Such epoxies are described in U.S. Pat. No. 5,623,031. Other suitable epoxies that may be employed to practice the present invention are disclosed in U.S. Pat. Nos. 5,602,193; 5,741,835; and 5,910,548. The preferred epoxies are those derived from bisphenol A, bisphenol S, bisphenol F, and novolak resins. The most preferred are those derived from the bisphenol A, novolak resins, and an epoxy obtained by the reaction of bisphenol A and epihalohydrin.

When an epoxy is included in the primer, the epoxy composes from 10% by weight to 70% by weight of the primer. Typically, epoxies compose from 30% by weight to 50% by weight of the primer. Organo-silicon compounds and silsesquioxanes are included in amounts of 0.5% by weight to 25% by weight, preferably from 5% by weight to 15% by weight of the primer.

An example of a suitable polyimide that may be employed in the primer composition is a polyimide obtained by the reaction of tetracarboxylic acids or their mono- or dianhydrides with diamines. Examples of suitable dianhydrides are pyrometallic acid dianhydride, 2,3,6,7-naphthalene tetra-carboxylic acid dianhydride, 3,4,3′,4′-diphenyl sulfone tetracarboxylic acid dianhydride, perylene-3,4,9,10-tetra-carboxylic acid dianhydride, 3,4,3′,4′-diphenyl ether tetracarboxylic acid dianhydride.

Examples of diamines which may be reacted with the tetracarboxylic acids or their derivatives are 4,4′-diaminodiphenyl ether, 5-amino-2-(p-aminophenyl)-benzothiazole, 4-amino-2-(p-aminophenyl)-benzothiazole, 5-amino-2-(m-amino-phenyl)-benzothiazole, 5-amino-2-(p-aminophenyl)-benzoxazole, 4-amino-2-(m-aminophenyl)-benzothiazole, p- and m-phenylene diamine, 4,4′-diaminodiphenyl, bis-(4-aminophenyl)-methane, 4 amino-2-(p-aminophenyl)-benzoxazole, 4-amino-2-(m-aminophenyl)-benzoxazole, 5-amino-2-(m-aminophenyl)-benzoxazole, 2,5-diaminobenzoxazole or 2,5-diaminobenzthiazole.

Examples of polyurethanes include thermoplastic polyurethanes derived from a reaction product of polyester diols, polyether diols, a difunctional chain extender and an organic diisocyante. A difunctional chain extender may be aliphatic, cycloaliphatic or aromatic diols, diamines or aminoalcohols.

Rubbers that may be used to practice the present invention include both natural and synthetic rubbers. An example of a suitable rubber is a liquid copolymer of acrylonitrile and butadiene having a number average molecular weight of less than 30,000 with terminal vinyl functional groups.

Examples of suitable poly(meth)acrylates are polymerized monomers of alkyl acrylate, alkyl methacrylate, acrylic acid, methacrylic acid, or combinations thererof.

Other polymers or resins may be employed to make primer compositions. The foregoing examples are not limiting.

Organic oligomers and organic monomers have at least one α,β-ethylenically or acetylenically unsaturated group or have heat activated methylol groups. When a polymer material such as a pre-preg is applied or laminated to a roughened metal surface primed with a primer containing organic oligomers and organic monomers, the oligomers and monomers cross-link to form bonds to join the polymers of the primer composition to the polymer pre-preg to reinforce adhesion between the polymer pre-preg and the roughened metal surface. Such oligomers and monomers typically have from one to three unsaturated groups or two or more heat activated methylol groups. Preferably, the oligomers or monomers have at least two unsaturated groups or at least two heat activated methylol groups. Examples of oligomers are urethane oligomers. Examples of such monomers are alkyl(meth)acrylates, isocyanates, and melamine glycoural cross-linkers. Such oligomers and monomers when combined with one or more organic polymer compose from 5% by weight to 30% by weight of the primer, preferably from 10% by weight to 20% by weight of the primer.

After priming the roughened metal surface a layer of polymer material may be placed on the roughened and primed metal surface. The layer of polymeric material may include, but is not limited to, a pre-preg, an imageable dielectric, a photoimageable resin, a soldermask, an adhesive or a polymeric etch resist. All such polymeric materials may be applied to the roughened and primed metal surface by any suitable method known in the art. For example, mechanical pressure with heat may be employed to join the polymer to the metal surface. When heat is employed, temperatures may range from 30° C. to 110° C.

Metals, which may be used to practice the present invention, may be any metal that may be roughened mechanically or chemically or by any other suitable method, and primed such that a polymer layer may be bonded to the treated metal surface. Examples of such metals include, but are not limited to, copper, silver, nickel, gold, tin, lead, iron, cobalt, platinum, or alloys thereof.

The method of the present invention may be employed in any industry where a metal and a polymer material are to be bonded together. The method of the present invention is particularly suited for the manufacture of multi-layer printed circuit boards. Thus, in this application, metal circuitry (usually copper) of the inner-layers is roughened. After roughening, optionally followed by water rinsing, the inner-layers are primed with a primer of the present invention. Optionally, another rinsing step may be employed before applying the polymer layer to the metal.

In another embodiment of the present invention, the metal surface may be treated with an alkaline solution after the oxide alternative solution treatment but prior to the application of the primer composition. The preferred alkaline solution is an aqueous alkaline solution of alkali metal hydroxide (e.g. sodium hydroxide or potassium hydroxide); alkali metal carbonates (e.g. sodium carbonate or potassium carbonate); alkali metal phosphates (e.g. sodium phosphate or potassium phosphates); or amines or mixtures of those chemicals. The preferred amount of such chemicals in the aqueous solution depends upon the particular chemical employed as well as the exact use involved. Most preferably an aqueous solution of sodium or potassium hydroxide is used as the alkaline treatment, with the concentration of sodium or potassium hydroxide ranging from 2 to 150 grams per liter, most preferably from 25 to 50 grams per liter. Contact may be made by immersion, conveyorized flood or spray, however, conveyorized flood is preferred. Contact time may range from 20 seconds to 10 minutes but 1 to 3 minutes is preferred. Contact temperature may range from room temperature to 85° C. but 20° C. to 40° C. is preferred. This alkaline treatment reduces the number of flaws in the finished laminated product. After the alkaline treatment, the metal surface may be rinsed with water. The treated metal surface is then treated with the primer composition and then the metal surface is bonded to a polymer material by any suitable conventional process.

In another embodiment of the present invention, the roughening step may be a process for converting cupric-based organometallic compounds on a copper surface into cuprous-based organometallic conversion coatings. Such a process is achieved by reduction or by partial dissolution of the organometallic coating, and optionally applying a copper oxidation inhibitor at the same time.

The reduction or dissolution composition contains a reducer or dissolution agent, and optionally a copper oxidation inhibitor. Examples of reducers include, but are not limited to, DMAB (dimethylaminoborane), diethylaminoborane, morpholine borane and the like. Other suitable reducers include ammonium, alkali or alkaline earth metal borohydrides, hypophosphites, sulfites, bisulfites, hydrosulfites, metabisulfites, dithionates, tetrathionates, thiosulfates, thioureas, hydrazines, hydroxylamines, aldehydes (including formaldehyde and glyoxal), glyoxylic acid and reducing sugars. Electric current may be used as well.

Dissolution agents employed may include any of the known cupric ion chelators (complexors), organic or inorganic acids or their salts, (or a combination of them), can be utilized for the present application. Such dissolution agents include, but are not limited to, EDTA (ethylenediamine-tetraacetic acid), HEEDTA, NTA (nitrilotriacetic acid), DTPA (diethylenetriamine pentaacetic acid), DCTA (acetic acid), Quadrol® (ethoxylated/propoxylated ethylene diamine derivative available from BASF), organic phosphates (Dequests®), organic acids (citric, tartaric, gluconic, glutamic, sulfamic, glycolic, glycine, malic, maleic, salicylic, ascorbic, or formic), inorganic acids (hydrochloric, hydrofluoric, hydrobromic, nitric, or chromic acids), or their salts, ammonium hydroxide, pyrophosphates, or mixtures thereof. Quadrol®, EDTA and phosphonates are preferred. Additionally, it may be advantageous to use the dissolution agents with one or more reducing agents.

Cationic, amphoteric, anionic or non-ionic surfactants may also be utilized in the adhesion-promoting solution to enhance the effectiveness of the adhesion-promoting solution.

Proper pH, temperature, concentrations of components as well as treatment time are adjusted appropriately to insure effective reduction or dissolution of the cupric ion as disclosed in WO 00-02426 (PCT/US99/14983) published Jan. 13, 2000 (Applicant: Alpha Metals Inc.).

After the cupric-based organometallic compounds on the copper surface are converted into cuprous-based organometallic compounds by reduction or dissolution, the copper is primed. The copper surface may be rinsed with water before or after the priming followed by laminating the polymer material on the copper surface.

The following examples further illustrate the process and composition of the present invention but are not intended to limit the scope of the invention.

### EXAMPLE 1

Seven 30.5 cm×30.5 cm RTF® copper foils each having a thickness of about 4 mm are employed. Each copper foil is roughened with an aqueous dispersion of diamond particles having a diameter in the range of from 150 to 250 nanometers. The dispersion of diamond particles are applied to the surface of each copper foil by a standard compressed air dental cleaning tool. The dispersion of diamond particles are air blasted at a surface of each copper foil at a rate of 100 to 200 milliliters per minute for a period of 10 seconds or until the copper surfaces appeared matte to the naked eye.

After the surface of each copper foil is roughened, each copper foil except one, which acts as a control, is exposed to a primer solution for 30 seconds. The primer solution is composed of a 1.0% by weight of a uniform dispersion of a polyimide in deionized water. The temperature of the aqueous primer dispersion is at 20° C. The copper foils treated with the primer dispersion are rinsed with deionized water. The copper foils are then air-dried, and then baked at 100° C. for 10 minutes. All of the foils are then pressed using Nelco® pre-preg, one sheet of 7628, 4000® series and two sheets of 1080, 4000® series. The press is done using a Wabash® press standard press cycle of 1 hour and 45 minutes and 175 psi lamination.

Peel strength testing is then performed on the foils by means of the Instron® Peel Tester, model #2530-437 apparatus. Peel strength is measured in pounds per inch. Peel strength is the force required to separate the foil from the pre-preg material. The control, which was not treated with the primer dispersion, has a peel strength of below 6.0 lbs/in. The six other copper foils have peel strengths of 6.0 lbs/in or greater. Accordingly, workers may expect multi-layer circuit boards treated with the primer dispersion of the present invention to have improved bond integrity between cooper and a pre-preg layer.

### EXAMPLE 2

Five 30.5 cm×30.5 cm nickel foils each having a thickness of 4 mm are roughened with garnet particles having diameters of from 500 nm to 1000 nm. The aqueous dispersion of garnet particles are applied to a surface of each nickel foil by means of a compressed air dental tool. The particles are applied at a rate of 100 to 200 milliliters per minute for 60 seconds or until the treated surface appears matte to the naked eye. After each foil is roughened four of the five foils are treated at 20° C. with an aqueous primer solution composed of 0.75% by weight of nitrile rubber. The unprimed foil is a control. After the foils are treated with the primer solution, they are rinsed with deionized water. The treated nickel foils are then air-dried. All of the foils are then pressed using Nelco® pre-preg, one sheet of 7628, 4000® series and two sheets of 1080, 4000® series. The press is done using the Wabash® press standard press cycle of 1 hour and 45 minutes and 175 psi lamination.

Peel strength testing is performed on the foils by means on the Instron® Peel Tester, model #2530-437 apparatus. Peel strength is measured in pounds per inch. The control nickel foil had a peel strength of below 6.0 lbs/in. The four nickel foils had peel strengths of 6.0 lbs/in or greater. Accordingly, the primer solution of the present invention improves bond integrity between a nickel and pre-preg material.

### EXAMPLE 3

Five 30.5 cm×30.5 cm copper/nickel alloy foils having a thickness of 4 mm are roughened with a pumice stone. Each foil is hand roughened until the surface of the foil appears matte to the naked eye. Four of the five foils are dipped into a primer solution composed of 2.0% by weight of a butadiene polymer. Each foil is dipped into the primer solution for 15 seconds at a temperature of 25° C. The foil, which is not treated with the primer solution acts as a control. After treatment with the primer solution, each of the treated foils is rinsed with deionized water, and then air-dried. All of the foils are then pressed using Nelco® pre-preg (polyethylene polymer) one sheet of 7628, 4000® series and two sheets of 1080, 4000® series. The press is done using the Wabash® press standard press cycle of 1 hour and 45 minutes.

Peel strength testing is then performed on the foils by means of the Instron® Peel Tester, model #2530-437 apparatus. The peel strength of the control is less than 6.0 lbs/in. In contrast the peel strength of foils primed with the primer solution of the present invention is 6.0 lbs/in or greater. Accordingly, the primer of the present invention improves the bond integrity between a roughened copper/nickel alloy surface and a pre-preg.

### EXAMPLE 4

Six 30.5 cm×30.5 cm tin/lead alloy foils each having a thickness of 4 mm are roughened on one surface by hand with a pumice stone. The roughening is performed until the surface appears matte to the naked eye. Five of the roughened foils are then dipped into an aqueous primer solution composed of a polyurethane. Each foil is left in the solution for 20 seconds at 23° C. The foil that is not treated with the primer solution is a control. After the foils are primed each is rinsed with deionized water, and air-dried. All of the foils are then pressed using Nelco® pre-preg one sheet of 7628, 4000® series. The press is done using a Wabash® press standard press cycle of 1 hour and 45 minutes and 175 psi lamination.

Peel strength is then performed on the foils by means of an Instron® Peel Tester, model #2530-437 apparatus. The peel strength of the control is less than 6.0 lbs/in. The peel strength of the foils treated with the primer of the present invention is 6.0 lbs/in or greater. Accordingly, the primer of the present invention improves bond integrity between tin/lead alloy roughened foils and a pre-preg.

### EXAMPLE 5

Four 30.5 cm×30.5 cm silver foils each having a thickness of 4 mm are roughened on one surface with ground pumice particles. The pumice particles range in diameter of from 250 nm to 1000 nm, and are applied in an aqueous dispersion with a dental compressed air cleaning apparatus. The dispersion of pumice particles is applied at a rate of 5 milliliters/minute until the surface of each silver foil appears matte to the naked eye. All of the foils are rinsed with deionized water to remove any pumice particles from the roughened surface.

Three of the foils are treated with an aqueous primer solution containing 0.5% by weight of an acrylic acid polymer. The three foils are dipped into the primer at 24° C. for 1 minute and then rinsed with deionized water, and then air-dried. The foil that was not treated with the primer acts as a control.

All of the foils are then pressed using Nelco® pre-preg one sheet of 7628, 4000® series and two sheets of 1080, 4000® series. The press is done using a Wabash® press standard press cycle of 1 hour and 45 minutes and 175 psi lamination. Peel strength is performed on the foils by means of an Instron® Peel Tester, model #2530-437 apparatus. The peel strength for the control is less than 6.0 lbs/in. The peel strength for the primed silver foils is 6.0 lbs/in or greater. Accordingly, the primer and method of the present invention provides an improved bond between a roughened metal foil and a pre-preg.

1-15. (canceled)

16. A method of treating a metal comprising:
a) mechanically roughening the metal;
b) priming the roughened metal with a liquid primer composition comprising an organic polymer, an organic oligomer, an organic monomer, or mixtures thereof; and
c) applying a polymer material to the roughened metal with the liquid primer to form a bond with the roughened metal.

17. The method of claim 16, wherein the metal is mechanically roughened by air blasting, hand rubbing, brushing, or mechanical wheels.

18. The method of claim 17, wherein an abrasive used in mechanical roughening comprises diamond, garnet, or pumice.

19-20. (canceled)

21. The method of claim 16, wherein mechanical pressure, heat or combinations thereof are applied to form the bond between the polymer material and the roughened metal surface.

22. The method of claim 16, wherein the organic polymer is a polyimide, a poly(meth)acrylate, a polycyanoacrylate, a rubber, a polyurethane, a butadiene, or mixtures thereof.

23. The method of claim 16, wherein the organic oligomer is a urethane.

24. The method of claim 16, wherein the organic monomer is a (meth)acrylate, an isocyanate, melamine glycoural cross-linker, or a heat activated methylol.

25. The method of claim 16, wherein the liquid primer further comprises one or more epoxy.

26. The method of claim 16, wherein the liquid primer further comprises one or more organo-silicon compounds or one or more silsesquioxanes.
